(19) United States
(12) Patent Application Publication
(10) Pub. No.: US 2021/0403157 A1
(43) Pub. Date: Dec. 30, 2021

(54) Command and Control Systems and Methods for Distributed Assets

(71) Applicant: Titan Innovations, Ltd., Herzliya (IL)

(72) Inventor: Jacob Thompson, Beverly Hills, CA (US)

(21) Appl. No.: 16/983,703

(22) Filed: Aug. 3, 2020

Related U.S. Application Data
(60) Provisional application No. 62/884,160, filed on Aug. 7, 2019.

(51) Int. Cl. B64C 39/02; G05D 1/00; B64F 1/36; G05D 1/10; E04H 6/44; G06T 17/05; G06T 19/00; G06T 17/20

(52) U.S. Cl. CPC B64C 39/024; G05D 1/0027; B64F 1/362; G05D 1/104; G06T 2219/004; G06T 17/05; G06T 19/00; G06T 17/20; B64C 2201/146; E04H 6/44

(57) ABSTRACT

Various embodiments of a command and control system of distributed assets, including drones, other mobile assets, and fixed assets. Optionally information is gleaned from sensory units and transformed into a pictorial representation for easy understanding, decision-making, and control. In some embodiments, the pictorial representation is in a 3D image. Optionally a user interface that is designed for particular usages, and that in some embodiments may be customized by different operators. Optionally sensory units or assets are in communicative contact in a mesh network. Various embodiments of methods to operate command and control systems.

### CROSS-REFERENCE TO RELATED APPLICATIONS

This application claims the priority of U.S. Provisional Patent Application No. 62/884,160, filed Aug. 7, 2019. This Provisional Patent Application is fully incorporated herein by reference, as if fully set forth herein.

### BACKGROUND

### 1. Technical Field

Some of the disclosed embodiments describe command and control systems of distributed assets including drones, other mobile assets, and fixed assets.

### 2. Description of Related Art

Current devices, systems, and methods for managing and processing data from drones, other mobile assets, and fixed assets, suffer from a variety of disadvantages. Current systems do not allow real-time dynamic mapping in three dimensions (“3D”) from a variety of assets and sensors.

In systems that include human involvement, processing of data into information, and the form in which that information is presented to the user, are critical to the person's ability to function quickly and effectively. Current systems, however, lack dynamic user interface (“Dynamic UI”) to focus the user's attention on a particular event or action or problem or need for a decisions. Further, there is an absence of UI in which the user may either rely on machine presentation, or define his own presentation, or override machine presentation in cases of interest to the user.

Over time, the number and complexity of sub-systems involved in a C&C System continue to increase. Not only must the current System control all such sub-systems, integrate data from them, process such data into information, and present such data to users, but in addition the task becomes more complicated and difficult over time. A system is needed that can handle all such tasks, and integrate more sub-systems and much more data, on both a planned basis and a real-time basis.

### SUMMARY

Described herein are various embodiments of systems and products for managing and processing data from drones, other mobile assets, and fixed assets. Also described herein are various methods for operating such systems. Also described are various dynamic user interfaces used with such systems.

One aspect of real-time mapping is an ability to take live feeds of sensory input (typically video, but in alternative embodiments may be alternatively or supplementary auditory, olfactory, or other), with the live positions of remote assets and sensors, to create a 3D map of what can be seen by each remote asset or sensor, and combine these multiple models into one 3D model of the environment of interest. Real-time mapping may be done automatically by machine processing, or by a joint human action in selecting what is to be enhanced or reduced (typically known as “data scrubbing”) which is then performed by machine processing.

By using a blend of camera footage, positioning data, visual markers, computer vision, and video processing, the Command & Control (“C&C”) System can create real-time 3D models/maps of an environment or object. The C&C System will create an optimal path for all the autonomous remote assets to travel in order to create the best data set. By knowing the starting position of each drone/camera/asset, each video can then be automatically synched together along with the continued position, height, and orientation data from each asset to build a full set of video coverage. These videos are then stitched together and put through a set of software processes to create, build, and deliver a 3D model of the target area. In some embodiments, the model is “interactive” in that the user may create scenarios with altered times, positions, or actions, or may ask the system questions in writing or verbally to obtain clarification of the meaning of the model. If there is incomplete data in a model, or a change in the environment requiring either new data or a new model, the user of the C&C System could then indicate the geographic area(s) that need additional passes which would automatically send the assets on new optimal paths. Such model updating could also be set to an automated process to constantly keep the assets in a dynamic patrol that would continuously update the 3D model.

(2) Dynamic UI:

The user interface (“UI”) to a person, which is typically located either in or at the physical location of the tablet or other portable device, portrays the 3D map, dynamically updated by events in the field. Also, when something of interest happens, the configuration of the map will change in order to accommodate, either by enlarging or otherwise making more prominent, the noteworthy act or event. That change may be done entirely by the portable device or other processing unit on the one hand, or may be a combination of the user giving a command and the system complying. Such user interface is considered to be dynamic (“Dynamic UI”).

One aspect of Dynamic UI, according to some embodiments, is that the system will work substantially simultaneously with the live data from the assets, input from the user, mission parameters, a database of past missions, and machine learning, all together, in order to automatically prioritize the information that is highlighted in the user interface at any moment. This feature allows a single user to be able to control numerous independent systems simultaneously, process large amounts of data quickly, and make mission-critical decisions as efficiently as possible. For example, this Dynamic UI system could range from simply automatically enlarging a video feed with a potential target spotted, to automatically giving new order prompts to the assets while waiting for user confirmation of review.

(3) Integration of Multiple Sub-Systems:

This C&C System is a one-stop shop for every aspect of a mission. This starts with integrating databases or the ability to pre-load content to include the most up-to-date satellite maps or surveillance briefings in a live mission UI. Then integrating a launch platform to automate all of the charging, launching, refueling, and landing protocols of the remote assets and sensors, without needing user input. Next is the mesh network in order not only to stream data as quickly as possible, but also to ensure communications among sub-systems even when traditional communication fails. The C&C System includes also integration with asset flight commands, instruments/sensor data, and mission protocols. In this sense, “sensor data” may be any kind of sensory data, such as vision (by ordinary visible light, infrared vision, or any other), auditory, olfactory, or other, including the instruments by which such data are discovered and conveyed (for example, cameras for visual data, or listening devices for auditory data). In this sense, “protocols” are rules for execution of the mission, such as, for example, “Don't operate outside these geographic coordinates,” or “If you receive any signal within radio frequency band X, move towards its source,” or “Do replace a drone if it is interrupted or shut down,” or conversely “Don't replace a drone that is interrupted or shut down.” By putting all these sub-systems and protocols together, one user would be able to fully control every asset being used during execution of the mission.

(4) Mesh Communication with On-Load and Off-Load Processing:

In some embodiments, a portable device executes both communication with the distributed assets, and processing of their data into information which may be displayed to a human user and on which decisions and actions may be taken. Such embodiments are “on-load” in the sense that the processing is done by the portable device without a separate processing unit. In these embodiments, all of the units operate in a mesh communication network, in which the portable device is in communication to and from the distributed assets, and in addition the distributed assets are in communication with one another. In the event of failure of any unit, other units can take up the communication burden. Further, since communication can be sent in a chain of units, the distances that may be travelled by distributed assets may be greater, and the communication difficulty of a particular area may be greater, without disrupting system communication.

Some alternative embodiments are “off-load,” in the sense that the control function is split between a portable device that communicates with the distributed assets, and a processing device that does some or most or even all of the processing of data from the distributed assets into usable information. The separate processing device may be connected to the portable device, or not connected but in close proximity to the portable device, or remote from the portable device either a mobile device itself or in a fixed location. The separate processing device may be in direct communication with the distributed assets, or may alternatively receive the raw data of the distributed assets via the portable device. The separate processing device and the portable device are in direct communication. As in the on-load mode, the off-load mode may involve a mesh communication network, so that the distributed assets are in communication with each other in the event of failure of any unit, other units can take up the communication burden. Further, since communication can be sent in a chain of units, the distances that may be travelled by distributed assets may be greater, and the communication difficulty of a particular area may be greater, without disrupting system communication.

In all embodiments of the off-load mode, some or most or all of the processing of data is executed by the processing device. In some embodiments, this may relieve significantly the processing burden on the portable device, which would free the portable device's computational resources to improve communication, and which could allow the design of a smaller, lighter, cheaper portable device, what is sometimes called a “thin” or “dumb” terminal, in which the processing device is considered “fat” or “smart.” In some embodiments, pre-processing conducted by assets, before messages are sent to the portable device, are also unnecessary, because the pre-processing device will conduct both the pre-processing formerly conducted by the distributed assets and also some or all of the processing formerly required of the portable device. Further, since there is a unit dedicated solely to processing, this processing unit or device may be designed for very strong processing, thereby enhancing operation of the entire System. This would mean that instead of requiring the user tablet or other portable device to have enough processing power to do all the real-time processing, videos from the assets could be sent to a processing device or a “CPU farm,” and the result of the finished processing could then be streamed back to the portable device via the meshwork. All of this would require significantly less processing power from all in-field assets in the off-load mode than in the on-load mode.

### BRIEF DESCRIPTION OF THE DRAWINGS

For a fuller understanding of the nature advantages of various embodiments described herein, reference should be made to the following detailed description in conjunction with the accompany drawings.

FIG. 1 illustrates one embodiment of a system for real-time mapping of a target or geographic location.

FIG. 2 illustrates one embodiment of a method for real-time mapping of a target geographic location.

FIG. 3 illustrates one embodiment of a device and system with dynamic user interface for mapping a target or geographic location.

FIG. 4 illustrates one embodiment of a system that integrates multiple sub-systems in a mesh network, with command & control, and integrated maps and external intelligence.

FIG. 5 illustrates one embodiment of a system with a mesh communication network and a command & control unit.

FIG. 6 illustrates one embodiment of a system with split communication and processing, including, in one embodiment, a thin portable device and a fat processing device.

FIG. 7 illustrates one embodiment of a system with mobile, fixed, and human assets.

FIG. 8 illustrates a system for ground control, including a mobile asset with means to disperse crowds and a mobile asset with a magnetic catch & release mechanism.

FIG. 9 illustrates a system of a fixed attachment to a mobile asset, in which the attachment is a means to disperse crowds.

### DETAILED DESCRIPTION OF VARIOUS EMBODIMENTS

As used herein, the following terms have the following meanings:

“Commands to the drones” or “commands to the assets” are any of a variety of commands that may be given from either a portable unit or a central unit to a drone in relation to a particular target. Non-limiting examples include “observe the target,” “ignore the target,” “follow the target,” “scan the target,” “mark the target,” and “attack the target.”

“Distributed assets,” sometimes called merely “assets,” are devices in the field that are collecting data and sending to a point at which the data is processed into a map. One example of a mobile asset is a drone, but other mobile assets may be on land, at sea, or in the air. The term “distributed assets” may also include fixed assets which are permanently or at least semi-permanently placed at a specific location, although the sensing device within the asset, such as camera, may have either a fixed area of observation or an ability to roam with the fixed asset, thereby changing the field of observation.

“Drone” is a type of mobile distributed asset. When it appears herein, the term does not exclude other assets, mobile or fixed, that may perform the same function ascribed to the drone.

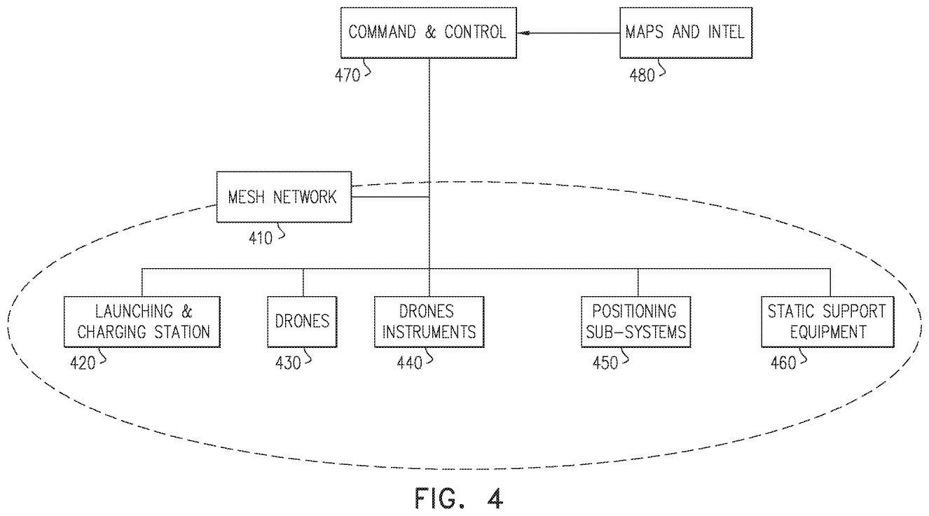

“External intelligence” is information that is gleaned from outside a Command & Control System, which is then incorporated with real-time data within the system. External intelligence may be updated in real-time, or may be relatively fixed and unchanging. One alternative method by which external intelligence may be gleaned is illustrated in FIG. 4. An example of external intelligence, illustrated in FIG. 4, is the location of a power line in particular setting.

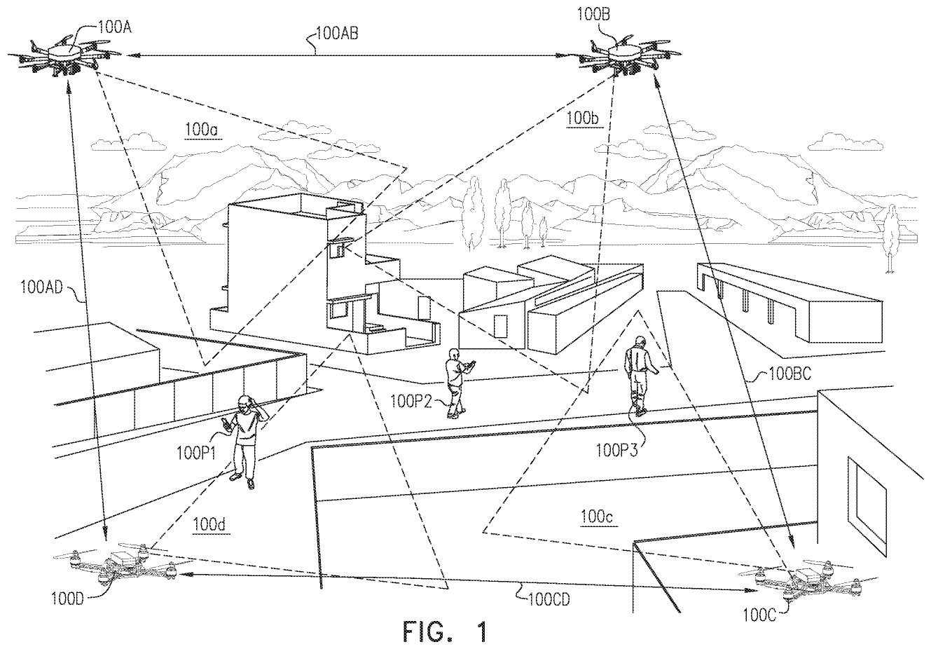

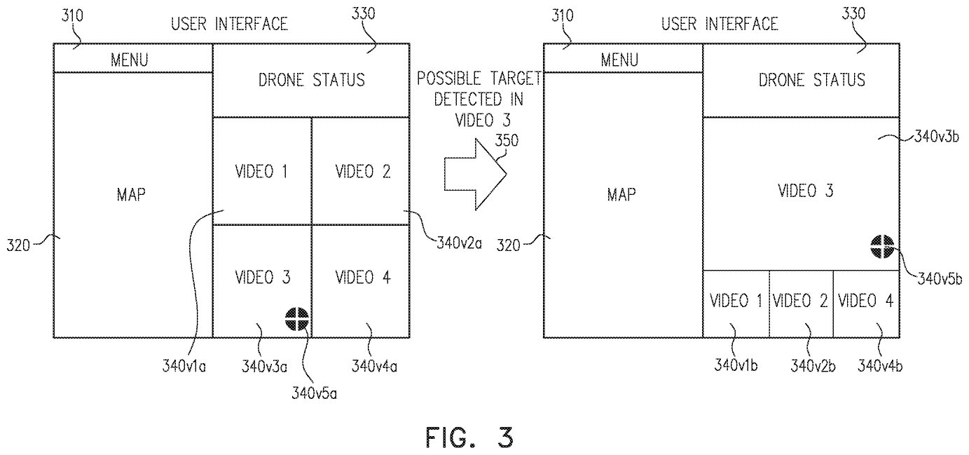

“External map” is a map taken from an external source, such as the Internet. For example, a map of the various buildings in FIG. 1 may be taken over the Internet from satellites, and overlaid on the unified pictorial representation of the area. One potential use of a map is illustrated in FIG. 3, where a map is used to help determine which of the videos, if any, demonstrate any unusual or noteworthy image in the target area.

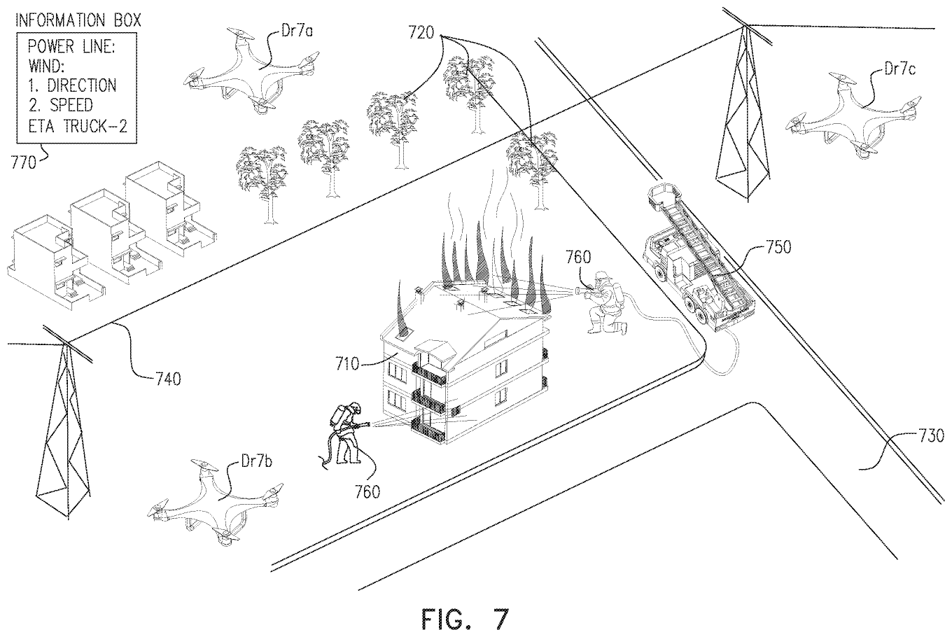

“Fixed assets” are sensors whose data may be received by a command & control unit, and which may receive and execute orders from such a unit. In FIG. 7, wind sensors are not shown, but they would be part of a system providing real-time data to firefighters fighting a home fire, as shown.

“Mesh network” is a group of units, either all the same units or different kinds of units, in which the units are in communicative contact directly and dynamically to as many other units as possible in the network. In this sense, “direct” means unit to unit contact, although that does not impact a unit's contact with portable units or processing units. In this sense, “dynamically” means either or both of data conveyed in real-time, and/or the communicative contacts between units are updated consistently as units move position and either lose or gain communicative contact with other units. Some mesh networks are non-hierarchical in that all units may communicate equally and in with equal priority to other units, but that is not required and in some mesh network some of the units may either have higher priority or may direct the communicative contacts of other units.

“Mobile assets” Such asserts may be mobile or fixed including drones, vehicles, and sensors of all types such as visual, auditory, and olfactory, measuring location or movement or temperature or pressure or any other measurable item, are included within the concept of “distributed assets” subject in part of a Command and Control System (“C&C System”). In FIG. 7, a system includes both drones and a fire truck, both of which are mobile assets. Further, humans acting in concert with other assets, may also be “mobile assets,” as shown in FIG. 7.

“Pictorial representation” is a conversion of various data, which may be numerical, Boolean (Yes-No, or True-False, or other binary outcome), descriptive, visual, or any other sensing (olfactory, auditory, tactile, or taste), all converted into a visual posting in a form such as a map with objects and information displayed visually, or drawing, or a simulated photograph, or other visual display of the various data.

Brief Summary of Various Embodiments:

The Command & Control (C&C) System delivers start-to-finish simultaneous operation/mission control of multiple autonomous systems to a single user from a single device. One example is a drone group but the System can manage any assets on or under the land, in the air, on or under the sea, or in space. The assets may be mobile or stationary, and may include, without limitation, sub-systems including drones, robots, cameras, self-driving vehicles, weapon arrays, sensors, information/communication devices, and others.

Further, in various embodiments there is a tablet or other portable device for aggregating communication to and from the remote assets. In some embodiments, the portable device also processes the information from the assets, although in other embodiments much or all of the processing may be done “off-line” by a separate processing unit. In some of the embodiments described herein, a person is involved, typically as the site of the portable device, although a person may be involved also at a processing device (in which case it may be one person for the two devices portable and processing, or different people for each device). In other embodiments, there are no people involved at one or more stages, and the System may manage itself.

Among some experts in the art, the degree of machine autonomy is discussed according to various levels, which, by some people, including the following:

Level I: No machine autonomy. The machine does only what the human specifically orders. For example, when a person fires a gun, the gun has no autonomy.

Level II: The machine is relatively autonomous when switched on, but with very little flexibility or autonomy. For example, when a robotic cleaner is switched on but can only vacuum a floor.

Level III: A system or asset is launched or turned on, and progresses to a certain point, at which the human must confirm that the operation is to continue (as in pressing a button to say, “Yes, attack,”) or conversely that the operation will be executed automatically unless the human says “stop” (as in pressing a button to terminate an operation).

Level IV: This is the level of what is called “complete machine autonomy.” Humans give a very general instruction, and then leave the system, including the control center and the remotes assets, to decide what to do and how to do it in order to execute the general instruction. For example, “Drive back the enemy,” or “Find out what is happening at a certain intersection or within one kilometer thereof, in particular with reference to specified people.” In essence, the people give a mission, but the machines both create and execute the plan.

The various embodiments described herein may operate at any or all of the four levels, although it is anticipated in particular that this System will operate at some version of Level III and/or Level IV.

One aspect of the C&C System is the connection of all the sub-systems needed to run an operation from planning to launching to retrieval to post-operation analysis, all while some of the assets or a mobile control station are in the field. The sub-systems combined into the C&C System include, but are not limited to: communication, data streaming, piloting, automated detection, real-time mapping, status monitoring, swarm control, asset replacement, mission/objective parameters, safety measures, points-of-interest/waypoint marking, and broadcasting. The fact that the System, specifically a person with a portable device for communication and/or processing, may be deployed in the field rather than in an office or other fixed location, means that the system is very easy to deploy remotely, easy to use, and dynamically adjustable, with a user interface (“UI”) that is easy to use, flexible, and easily adjustable either by a person or automatically in some embodiments.

Further, an additional potential advantage of deployment in the field is that the System may operate in the absence of what is considered standard communication infrastructure such as an RF base station and network operation control center. The RF base station is not required, and the processing of the control center may be done by the portable device (called here “on-load processing”) or by another processing device located remotely from the portable device (called here “off-load processing”). In off-load mode, the processing device does some or most or all of the processing, and communicates the results the results to the portable device in the field. The processing device may be in a fixed location, or may also be mobile, in some embodiments the portable device and the processing device are in close proximity, even next to one another, but the portable device communicates with the remote assets whereas the processing device processes the results (and such processing device may or may not be direct communication with the remote assets, according to various embodiments).

In one exemplary embodiment involving assets, a single user may deploy in a mission area with a tablet or other portable device for communication and processing, connected via a mesh network to a docking station containing a group of assets. The user would open the device and have a map view of his current coordinates on which the user would use the touch screen to place markers on the map to outline the mission environment. The user would then select from prebuilt mission parameters, objectives, and operating procedures which would indicate what actions the assets will take. (The user could also create new behavior on-the-fly by using context menus or placing markers on the map and selecting from actions.) Once these are all locked in, and any relevant Points of Interest or Objective Markers have been put down on a map, the user would have an option to launch the mission. Once the mission is launched, the C&C System may automatically start sending out commands to the docking station and the assets. The docking station would open and launch all the needed assets which would the follow their predefined orders to all fly to specific heights, locations, and orientations all without the need of any pilots or additional commands (The user would be able to modify any mission parameters, objectives, or operations during the mission or could even send direct commands to individual assets that could contradict preset orders) While the assets are active, the user would have live information of all asset positions, orientations, heights, status, current mission/action, video, sensor, payload, etc. The C&C System also has the unique ability to use the live video and positions from the assets to create real time mapping of the mission environment or specific target areas using computer vision technology included in the C&C System. The user may also choose any video feed from any asset and scrub back thru the footage to find a specific time in the footage and even play it back at lower speeds and then jump right back to the live feed. Another important feature of the C&C System is the simplified User Interface which allows a single user to keep track of huge amounts of information and multiple simultaneous video/sensor feeds by using priority based design schemes and automated resizing, information prioritization, pop-ups, and context menus to allow for the C&C System to curate and simplify what is on the user's screen at any given moment to best support the active mission. During the mission, another important feature of the C&C System is its ability to have the assets not only communicate with each other to provide fast information sharing, but also to create a safety net for any and all possible errors or system failures. Since each asset is communicating with all the others, if any kind of communication or system error happens, the assets are able to automatically still carry out their mission parameters or enact fallback procedures. This also means that if one or more assets run out of batteries/fuel, are damaged, or otherwise cannot complete their mission, the other assets are able to communicate to each other or to the C&C System to automatically pick up the slack and cover the missing asset's mission objectives. Once all mission parameters have been completed, or the user chooses to end the mission, all the assets would automatically return to their docking station, self-land, and power off. After the mission, the C&C System would then be in post-mission assessment mode where the user could review all the parameters, data, video, decisions, and feedback throughout the whole mission. The user would also be able to scrub through the whole mission timeline to see exactly what happened with each element of the mission at each minute. Their mission map would still be interactive during this mode, allowing them to dynamically move the map at any point on the mission replay timeline to see the data from different angles. All of the mission information/data could also be live streamed to other C&C stations or viewing stations, where the data could be backed up or the data could be uploaded later from a direct connection to the tablet or other portable device.

Since the communication network is specifically a mesh network, the assets or other remote assets may be in direct contact with the portable device (and/or processing device). They may also be in contact with one another, and in some embodiments there may be a chain communication to and from remote asset A, from and to remote asset B, and to and from the portable device in the field and/or the processing device.

In various alternative embodiments, the C&C System will have one or more mission parameter/objective creator modes where advanced users could create new behaviors for their drones/assets to engage in to adapt to the ever-changing environments in which they function. This mode could also facilitate creating an entire mission timeline so that a field user could have a one-touch mission loaded up when he or she arrives at the launch location. Mission and objective parameters, or Mission/Objective Parameters, or MOPs for short, mean that any project or operation or task becomes a “mission” with goals to be achieved, and “objectives” which are sought in order to achieve the goals. It is also possible, in some embodiments, to have negative objective parameters, such as not to harm people or a particular building. One possible purpose for this mode would be to allow behaviors and adaptations to be added constantly to the System. The C&C System would be robust enough so that modifications or updates to the System could be easily integrated into the System in the future, allowing for augmentation of operational capabilities. Non-limiting examples of such augmentation include creating a specific automated patrol routine for a complicated and/or dense geographic area, building one or more protocols for different kinds of search & rescue environments, or building a decision hierarchy among different remote assets that have unique equipment. The last example envisions a situation in which different assets, drones or USV's or UGV's or other, have different capabilities and different roles, and the controlling unit, whether it is a table or portable unit, a processing unit, both portable and processing units, or another, must plan and execute a procedure for coordinating such different remote assets, including update goals and/or objectives and/or routines in a real-time mode based on what is happening in the environment. In various embodiments, with or without specialized or customized remote assets, goals or objectives or routines will be updated on a real-time basis.

Detailed Description of Various Embodiments with Reference to Figures:

FIG. 1 illustrates one embodiment of a system for real-time mapping of a target or geographic location. FIG. 1 is the first of two figures illustrating various embodiments of real-time mapping. For such mapping, there are multiple distributed assets, here four drones 100A, 100B, 100C, and 100D. Each drone has its own camera view with a particular field of vision, here field of vision 100a for drone 100A, field of vision 100b for drone 100B, field of vision 100c for drone 100C, and field of vision 100d for drone 100D. These fields of vision, taken together, are intended to give a comprehensive view of a particular target, be it a geographic view as in FIG. 1, a building a person, or other. As shown here, most, although not necessarily all, of the scene within one or more of the fields of vision for the drone fleet. Person 100P3 is entirely within the vision of drone 100C at this point in time, while person 100P1 is partially within the field of vision of drone 100D, and person 100P2 is not within any of the fields of vision at the particular moment of time show in FIG. 1. The drones may be in temporarily fixed locations, or they may be moving, each according to its particular flight path, and they will be continuously viewing the target as they move. In some embodiments, the drones may be stationary but their cameras may move so that the field of vision is changing.

As the drones maintain position or move along their respective flight paths, they continue to take video pictures of the target, particularly of points of interest in the target. The drones send all this data back to a unit that processes the data, which may be portable device, or a centralized processing device. That data is used by the processing unit to create a 3D model of the point of interest, and also allows decisions about continuations or changes in flight paths, placement, height, angle of visuals, and other positional aspects of the drones. In some embodiments, the drones are in direct communicative contact, which they may use for one or more of three purposes—first, to convey data from one drone to another, where only the second drone is in communicative contact with the portable device or centralized processing device; second, to communicate with one another such that their visual coverage of the target area is maximized over time; and third, to focus particular attention, with two more drones, on a particular event or object of interest at a particular time, even though there may be some or substantial overlap of the fields of vision for the two drones. In FIG. 1, for example, there are communicative contacts between the first and second drones in 100AB, the second and third drones in 100BC, the third and fourth drones in 100CD, and the fourth and first drones in 100AD. At the particular time illustrated in FIG. 1, there is no direct communicative contact between the first 100A and third 100C drones, nor between the second 100B and fourth 100D drones, although that may change as the drones continue to move. Although the example given here is entirely mobile assets, in alternative embodiments the mobile assets may combine with one or more fixed assets, places at particular locations, to give an improved image of the target. All of the embodiments described herein, and all the examples, including one or multiple mobile assets, and may include, in addition to the mobile assets, one or more fixed assets.

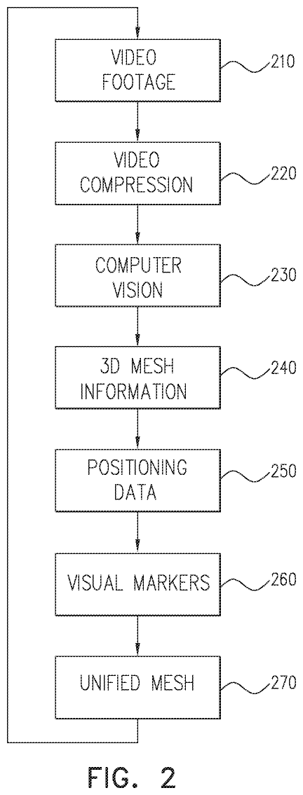

FIG. 2 illustrates one embodiment of a method for real-time mapping of a target geographic location. FIG. 2 is the second of two figures illustrating various embodiments of real-time mapping. Here a process with seven steps is illustrated, and the process repeats.

In step 210, video data is captured starting with a known image or position that is the target of interest. This is done by each of the units in a fleet with multiple assets, such as, for example, several drones in the drone fleet. This example will use drones, but it is understood for a fleet of assets on land, or a fleet of assets on the water, or a combined fleet with air and/or land and/or water assets.

In step 220, each drone compresses its video data to enable quick processing and transfer.

In step 230, there is a point or multiple points for processing the video data. Pre-processing prior to transmission, may be performed by drones. The pre-processed data is then transferred to a processing unit, such as a portable unit or a centralized processing device. Upon receipt, the portable device or processing device will process the data into information. The processing unit (portable device or processing device) applied computer vision algorithms to create known mesh points and landmarks. The overall process of receiving and processing data to create a map of known mesh points and landmarks may be called “computer vision.”

In step 240, the processing unit creates a 3D mesh from the video footage received from drones. The processing unit also creates a computer vision point cloud.

In step 250, the processing unit uses positioning data among the multiple drones and their cameras to create a shared position map of all the cameras' paths.

In step 260, the processing unit uses shared visual markers from the initial positions of the drones, and throughout each drone's flight, to combine the separate meshes into one map of the drones in correct positions and orientations to receive a continuing image of the target. In this sense a “separate mesh” is the mesh of views created by a continuously movie video from a single drone. When these separate meshes are used with known positions and angles, as well as landmarks, correct positions and orientations of all the drones may be calculated on an essentially continuous basis.

In step 270, the combined separated measures are unified by the processing unit to create a single unified mesh within the Command & Control System, in essence a 3D visual map of the target at a particular time, and then changing as the drones continue to move.

This process, steps 210 to 270, is repeated to continue to update a unified mesh image of the target area.

One embodiment is a method for real-time mapping by a mesh network of a target. In a first step, one or more drones capture data about the location of a certain target area or person of interest, and compress the data. In some embodiments, the drones then send that compressed data to a processor, which may be a portable unit, or a separate processing unit, or both. In other embodiments, each drone or some of the drones may process raw data into a 3D model for a drone, and that 3D model is then transmitted to the processor together with the raw data and location data of the drone. The drones send also positioning data and orientation data for each drone. The processor, be it a portable device or a separate processing unit or both, will process any raw data that has not 3D model into a 3D model for that drone. Positioning data and orientation data are added to the 3D model for each drone. Using the collective positioning and orientation data from all the drones, and visual markers that are unique to the target area, the processor creates a single 3D map of the target area. The map is configured in such a way that it may be updated as new data is transmitted to the processor from the drones.

In an alternative embodiment to the method just described, in addition the drones collect and send updated data, which is used by the processor to create a continuously updated 3D map of the target area.

In an alternative embodiment to the method just described, in addition processing occurs within the mesh network, and the mesh network sends, in real-time, an updated map to a command and control unit configured to receive such transmission.

In an alternative to the method just described, in addition the command and control unit combines an external map of the area in which the target is located with the single map received, in order to produce a unified and updated map of the target and the area in which the target is located. The command and control unit may obtain such map from the Internet or from a private communication network.

In an alternative to the method just described, in addition the command and control unit integrates external intelligence into the unified and updated map. Such external intelligence may be obtained from the Internet or a private communication network. It may include such things as weather conditions, locations of various people or physical assets, expected changes in the topography, or other.

FIG. 3 illustrates one embodiment of a device and system with dynamic User Interface (“UI”) for mapping a target or geographic location. The User Interface seen by a human user initially is shown at the left. On the UI screen, there is a menu 310 of actions that may be taken by the user. The UI screen may also operate in automatic mode, according to criteria selected by the user. A map of the entire area target 320 is shown at left, which may be a unified map of different video feeds from one or more mobile assets, here drones, or may be a single map from one drone if that is deemed more accurate or detailed. The status of the mobile assets 330 is shown on the UI screen, indicating criteria such as in-service or out-of-service, distance and direction from the target, direction of movement, and speed of movement. Each video from the drones may have its own video feed to the UI screen. Here, for example, a first drone has video 1 340v1a, a second drone has video 2 340v2a, a third drone has video 3 340v3a, and a fourth drone has video 4 340v4a. In alternative embodiments, a drone may have two or more cameras, such that there is a video for each camera, but not a different drone for each video, since some of the videos are shared on one drone. On the left, all of the videos are given equal prominence in terms of size on the UI screen. However, as shown, some kind of target or person or incident is detected in video 3 340v3a, as shown in pictorial form in 340v5a. As the result of the detection of a target or incident, the status of the UI screen evolves 350 from the image at the left to the image at the right. This evolution 350 may be automatic as defined previously, or may occur specifically at the command of a human user.

Many of the elements at left and right may be unchanged, except that, as shown, due to the detection at 340v5a within video 3 340v3a, the screen allocation to video 3 has expanded greatly at right 340v3b, whereas the other video images, video 1 340v1b, video 2 340v2b, and video 4 340v4b, have contracted in size to allow a more detailed presentation of video 3 340v3b. In video 3 340v3b, the particular pictorial form of interest that was 340v5a is now shown as 340v5b, except that this new 340v5b may be expanded, or moved to the center of video 3 340v3b, or attached with additional information such as, for example, direction and speed of movement of the image within 340v5b, or processed in some other way. It is possible also, that more than one video will focus on 340v5b, although that particular embodiment is not shown in FIG. 3. Further, specific aspects of target image 340v5b may be emphasized or flagged in others ways, while other parts of the overall map considered less relevant, may de-emphasized. For example, changing colors of presentation, added words, added flashing lights, added bells or other auditory signals, may be present to allow quick, clear, and easy understanding of the changing status of the target 340v5b. Different emphases can also represent different conditions, with levels of severity. All of this may be determined solely by a machine, which may be the portable device or the processing device, or by a combination of the person with the machine.

One embodiment is a device configured to display dynamic UI about a target. Such device includes a user interface in an initial state showing a map and sensory data from a plurality of drones. The device is in communicative contact with a user, which may be as simple as the user looking at the device, or may be an electronic connection between the user and the device.

In one alternative embodiment to the device just described, further the device is configured to detect, and to display in the user interface, a change in conditions related to the initial state.

In one alternative embodiment to the device just described, further the detection occurs in real-time relative to the change in conditions.

In one alternative embodiment to the device just described, further the change in display occurs in real-time relative to the change in conditions. In some embodiments the change may occur automatically, without human intervention. In other embodiments, the change will occur at the command of a human user.

In some embodiments the change may occur automatically, without human intervention, and the human user is notified of the change in real-time. In other embodiments, the user indicates a manner in which the display should change to best present the change in conditions.

FIG. 4 illustrates one embodiment of a system that integrates multiple sub-systems in a mesh network 410, with a common command & control System 470, and integrated maps and external intelligence 480. Several features may be noted.
The C&C System 470 manages several sub-systems. A few non-limiting examples appear in FIG. 4. The launching & charging station 420 stores, charges, launches, and retrieves, drones or other distributed assets. This may be a single station for one asset, or a multiple station for multiple assets such as a multiple-drone docking station. Drones 430 or other distributed assets are controlled by the C&C unit. This may include any mobile or fixed assets, in the air, on the ground or under it, on the water or under it, or in space. Instruments on the drones 440 collect the raw data, and may include cameras of many types, auditory sensors of many types, olfactory sensors, recording devices, and more. They include also devices that allow communication between the drone and the C&C unit. Positioning sub-systems 450 include any components useful in determining position, such as GPS, WiFi, Angle of Arrival, Time of Arrival, Frequency of Arrival, radio, WiFi, or any other components for triangulating location and otherwise determining position. Static support equipment 460 includes fixed sensors, or units for launching assets such as missile launchers.
All of the units in the System, including both those in the bottom row and the command & control units, are part of a mesh communication network 410, which may include a Command & Control System 470 as part of the mesh network 410, communicating directly with any or all of units 420-460. In an alternative configuration, which is depicted in FIG. 4, the C&C System 470 is not part of the mesh network 410, hence not in direct communication, with the system units 420-460, but in indirect communication with such units through a portable unit or other processing unit that is not a party of the Command & Control System 470. In all cases the C&C System 470 is in communicative contact, but that may be direct with units as part of the mesh network 410, or only indirect through an intermediary that is itself in communicative contact with the mesh network 410.
Maps 480 and other intelligence 480 may be downloaded from the Internet, from other public sources, or from private sources, for placement with the C&C System, typically with the portable device or, in alternative embodiments, with a central processing device. This information from external maps and external intelligence 480 is used to plan an operation, judge the operation while in progress, and modify the execution of the operation in accordance with the downloaded information.

One embodiment is a command and control system for management of drone fleets. In some embodiments, such system includes a command and control unit for receiving data, which is configured to issue commands for controlling sub-systems. In such embodiments, the sub-systems are configured to receive the data and transmit it to the command and control unit.

In an alternative embodiment to the command and control system just described, further the sub-systems include (1) a docking station for storage, charging, launching, and retrieving drones; (2) one or more drones; (3) an instrument on each drone for receiving and transmitting the data; (4) a positioning sub-system on each drone for determining the position and orientation of the drone in relation to a target; and (5) static support equipment for receiving data or taking other action.

In an alternative embodiment to the command and control system just described, the system further includes a processing device configured to receive the data, and to process the data into a 3D model in relation to the pictorial representation of an area in which the target is located.

In an alternative embodiment to the command and control system just described, further the processing device is configured to transmit the 3D model to the command and control unit.

In an alternative embodiment to the command and control system just described, further the sub-systems are communicatively connected in a mesh network.

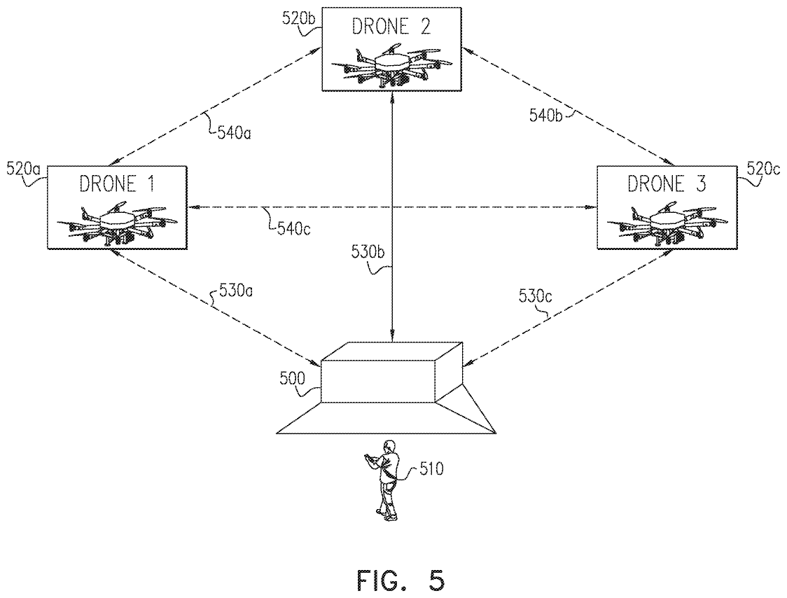

FIG. 5 illustrates one embodiment of a system with a mesh communication network and a command & control unit. The embodiment shows a central unit 500, which may be a portable unit, or a central processing unit, with both communication and processing capabilities. Any device or machine that has both capabilities—communication and processing—may be such a device 500. For example, a portable personal computer, an on-board computer on an armored personal carrier (“APC”), a handheld communicator, or another such device or machine.

Device 500 may operate automatically, or at the command of human user 510. There are three drones in this example, drone 1 520a, drone 2 520b, and drone 3 520c, each with a direct communication path to the portable device (530a, 530b, and 530c, respectively), and each with connection to the other drones (for drone 1, 540a and 540c; for drone 2, 540a and 540b; for drone 3, 540b and 540c). It is not required that all units be in contact with all other units all of the time. In a mesh network, the key thing is that at least one remote unit, let's say drone 1 520a, is in direct communication with portable device 500 acting as a controller, and one or more of the other remote devices drone 2 520b and drone 3 520c are in contact with the other unit that is in direct contact with the controller (for example, at some point in time path 530b may be broken or down, but drone 2 520b is still in contact with the controller through drone 1 520a on path 530a).

In the system portrayed in FIG. 5, all of the communication paths are two-way, and that is the case for paths 540a, 540b, and 540c between drones. The paths between the drones and the controller portable device 500, which are 530a, 530b, and 530c, may be two-way as shown, where the upstream path (that is, from drones to unit 500) are primarily to provide data, and the downstream path (that is, from unit 500 to drones) are primarily for command & control. A communication path may be one-way, either upstream or downstream, by design. Alternatively, the paths may be two-way, but if for any reason part of a transceiver malfunctions, a path may become one-way upstream providing data, or one-way downstream for command & control.

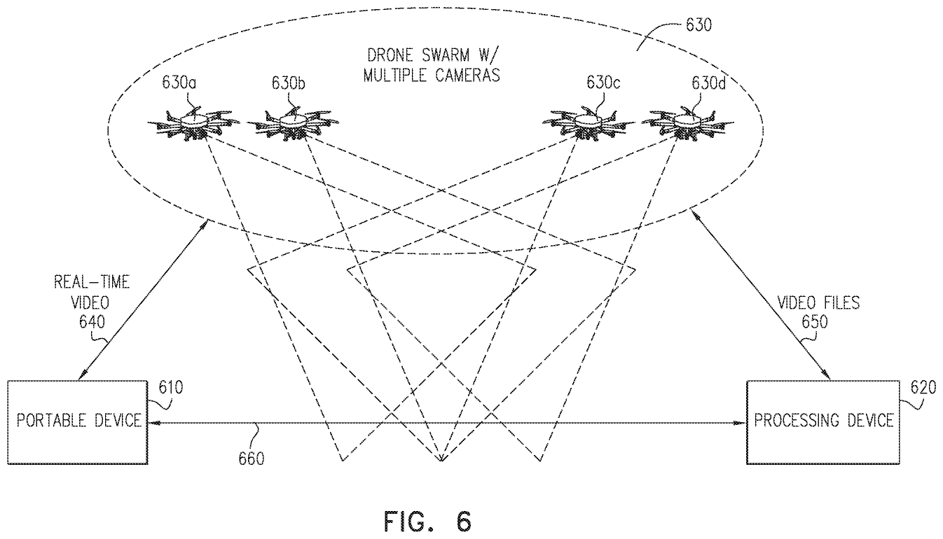

FIG. 6 illustrates one embodiment of a system with split communication and processing, including, in one embodiment, a thin portable device 610 and a fat processing device 620. Here, there is a swarm 630 of multiple drones 630a, 630b, 630c, and 630d, each drone with one or more cameras or other sensory devices, all focused on a target (target not shown). This is a system with off-load processing, meaning that in addition to the portable device 610 at left primarily for communication with the drones, there is also a processing device 620 at right primarily for processing the data from the drones 630a-630d into useful information based on 3D models and mapping. In this particular embodiment, the drones 630a-640 are in communicative contact directly with both the portable unit 610 and the processing unit 620, although in alternative embodiments the processing unit 620 may receive the data only from the portable unit 610 and not from the drones 630a-630d at all. The communication path 660 between the portable device 610 and the processing device 620 is essential when the processing device 620 communicates with the drones 630a-630d only through the portable device. Communication path 660 is optional when the processing device 620 communicates directly with the drones 630a-630d, but even in this case 660 can be useful in allocating processing between the portable device 610 and the processing device 620, or in providing processing redundancy if either 610 or 620 malfunctions.

FIG. 6 illustrates only one of many alternative embodiments. The term, “Real-Time Video Feed” 640 is data transmitted in real time that is either unprocessed by the drones 630a-630d or only very lightly processed (such as adding time stamps, or adding data frames), whereas “Video Files” 650 have been pre-processed by the drones, and are therefore delayed for at least a short time. In both cases communication may be two-way, either upstream for a processor to receive the data 640 or 650, or downstream to request such data. Some possible alternative embodiments include:

(1) No feed at all 640 or 650 to the portable device 610 acting as a controller, versus either real-time videos 640, or video files 650, or a mix of both according to defined criteria, transmitted by the drones 630a-630d to the processing device 620.

(2) No feed at all 640 or 650 to processing device 620, versus either real-time videos 640, or video files 650, or a mix of both by defined criteria, to the portable device 610. The portable device 610 would then relay feeds to the processing device 620, in some cases without any pre-processing by the portable device 610, and in other cases with some pre-processing by the portable device 610. In all cases, after the processing device 620 receives the feeds, it could perform significant processing, and then store part or all of the data, or send part or all of the data back to the portable device 610, or transmit part or all of the data to a receiver or transceiver located outside the system illustrated FIG. 6, or some combination of the three foregoing dispositions. In alternative embodiments, the portable device 610 may be in direct contact with a receiver or transceiver outside the system illustrated in FIG. 6.

(3) Any mix of feeds—real-time videos 640, video files 650, or a mix—to both the portable device 610 and the processing device 620 according to pre-defined criteria. In FIG. 6, we show only one possible embodiment, in which real-time video feeds 640 are transmitted to portable device 610 while video files 650 are transmitted to the processing device 620, but many different combinations of real-time video feed 640 and video files 650 can be sent to either or both of the portable device 610 and the processing device 620.

(4) All of the alternative embodiments, including the three described immediately above, are changeable according to time, changing conditions, or changing criteria. By “changing conditions,” the intent is factors such as change in the field of vision of specific drones 630a-630d, quality of the field of vision of specific drones, changing atmospheric conditions affecting communication, events occurring at the target, quantity of data being generated at each point in the system, need for processing of specific types of data, remaining flight time of drones, and other factors that can impact the desirability of collecting or transmitting either real-time video feeds 640 or video files 650. By “changing criteria,” the intent is rules regarding how much data should be pre-processed at which point in the system, how much data may be transmitted in what format at what time, ranking of data by importance, changes in the importance of the target, changes in the available processing power at the portable device 610 or processing device 620, and other factors within the control of system that could increase the quantity or quality of either the data collected and/or the information produced from the data.

(5) All of the foregoing discussion assumes one portable device 610, and one processing device 620, as illustrated in FIG. 6, but that is the structure and function of system only according to certain embodiments. In alternative embodiments, there may be two or more portable devices 610, at the same location or different locations, performing a variety of possible functions such as increased processing power, increased RAM memory for short-term storage, increased ROM for long-term storage, redundancy for fault tolerance or security, or other functions. In such cases, either only some or all of the portable devices 610 may be in direct contact with a processing device, and either some or all of the portable devices may be in direct contact with one or more drones. In other alternative embodiments, there may be two or more processing devices 620, and as with multiple portable devices 610, multiple processing devices 620 may function for increased processing power, increased RAM or ROM, redundancy, or other functions, in which either some or all of such multiple processing devices 620 may be in direct contact with the drones 630a-630d, and/or in direct contact with one more portable devices 610. In addition, in various embodiments one or more portable devices 610 may be in direct contact with transceivers outside of the system illustrated in FIG. 6, or alternatively or in addition one or more processing devices 620 may be in direct contact with transceivers outside they system illustrated in FIG. 6.

One embodiment is a system for real-time mapping of a target, including one or more drones for receiving sensory data from a geographic area and transmitting such data to a portable device, wherein the portable device is communicatively connected to the plurality of drones, and the portable device is configured to receive the sensory data transmitted from the drones.

In one alternative embodiment is the system for real-time mapping of a target just described, further the portable device is configured to process the sensory data received from the plurality of drones to create a real-time 3D model of an area in which a target is located.

In one alternative embodiment is the system for real-time mapping of a target just described, further the portable device is configured to send commands to the drones to perform actions in relation to the target.

In one alternative embodiment is the system for real-time mapping of a target just described, further the portable device is configured to retransmit the sensory data to a processing device and further the processing device is configured to process the sensory data received from the portable device to create a real-time 3D model of an area in which a target is located.

In one alternative embodiment is the system for real-time mapping of a target just described, further the processing device is configured to send commands to the drones to perform actions in relation to the target.

FIG. 7 illustrates one embodiment of a system with mobile, fixed, and human assets used in coordination for a specific purpose. In this exemplary system, a drone fleet Dr7a, Dr7b, and Dr7c, controlled by a command & control unit or portable device not shown, are acting in coordination with a fire truck 750 in a stationary position on a street 730, and with human firefighters 760, to quench a fire at a home 710. Fighting the fire 710 is complicated by the presence of trees 720, which are an example of one kind of physical obstacle to firefighting efforts. Another complicating factor is the proximity of a power line 740 which is problematic in two aspects—it may complicate the approach of firefighting assets, and it prevents a danger if the fire reaches the power line 740.

In the example presented in FIG. 7, a Command & Control System, either a portable device or a processing device not shown, would manage at a minimum the drone fleet Dr7a-Dr7c, and a maximum both the drone fleet and the other assets such fire truck 750 and firefighters 760. An example of the more inclusive embodiment is illustrated in FIG. 7. The information box at upper left 770 indicates the kind of information that may be generated by the Command & Control System from data collected from the drones Dr7a-Dr7c, and possibly also firefighters 760 and stationary assets 750, in addition to external maps and external information taken via the Internet or from a dedicated private information system. Here, for example, an external map would show the location of the burning home 710, the foliage 720, a proximate power line 740, and additional buildings in the area. Further, external information would indicate the presence of wind, the direction of the wind, and the speed of the wind, all of which are critical aspects in fighting a fire. Both the power line and the wind could be super-imposed on a map of the area for easy and quick reference by firefighters 760, those managing the fire truck 750, and the commanders overseeing the entire effort (who are not shown). Further, changes over time would be captured, including changes in the wind, and the estimated time of arrival, “ETA,” of other firefighting assets such as a second fire truck (not shown). The information box 770 could be presented in a variety of possible formats to firefighters 760 or others, such as, for example, super-imposed on the entire picture as shown in FIG. 7, or as a separate screen with the information. The essence is that with drones Dr7a-Dr7c, coordinated by a Command & Control System, in cooperation with other assets, the situation of the fire, and possible dangers to all parties and assets, can be identified and presented to interested parties in real-time. This is only one of many possible usages of a Command & Control System for mobile assets, as discussed further below.

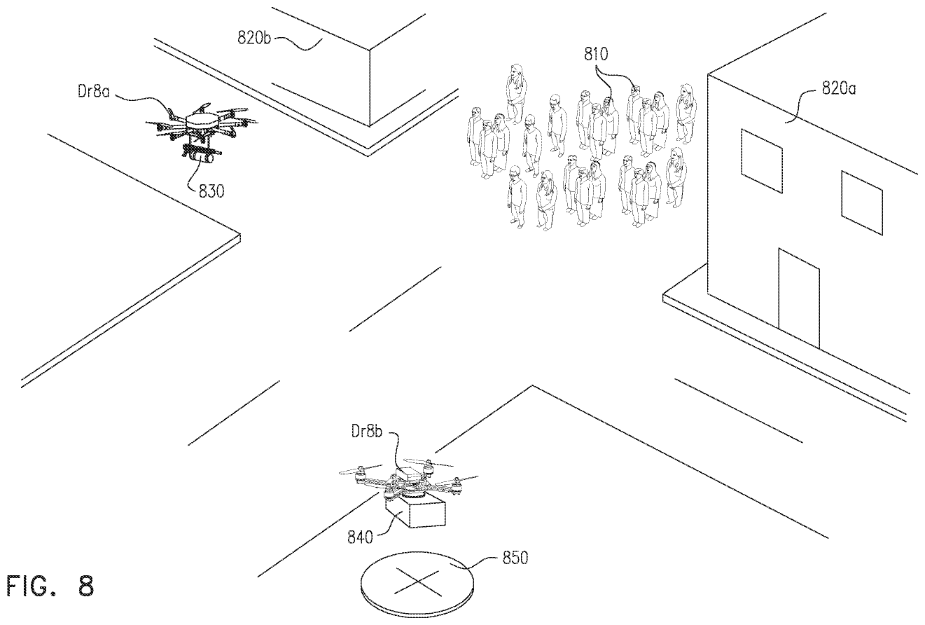

FIG. 8 illustrates a system for ground control, including a mobile asset with means to disperse crowds and a mobile asset with a magnetic catch & release mechanism. In FIG. 8 a crowd 810 has assembled in a confined space between buildings 820a, 820b. For whatever reason, and by some particular means, the crowd must be controlled. In FIG. 8, a drone Dr8a, controlled by a Command & Control System (not shown), as attached to it a device 830 for crowd control. This could be a loudspeaker to communicate with the crowd 810. It could be some kind of device for casting a material on the crowd 810, such as a gun for shooting a pepper ball or a foul smelling liquid or gas, or a noise emitter or emitting a high-pitched sound painful to the human ear, or some other device.

FIG. 8 also illustrates a second drone Dr8b, with some kind of material 840 attached to the drone Dr8b by a magnetic catch & release mechanism (not shown). Here, for example, drone Dr8B may have a box of medical supplies 840 which is to be placed at a drop point 850 in order provide a medical reserve for officers or paramedics on the scene. The box has been seized and held by and electromagnetic attached to the drone Dr8b and created by an electrical signal that was activated by a Command & Control System. As the drone Dr8b approaches the drop point 850, the electrical signal is discontinued to terminate the electromagnetism in such a way as to gradually open the catch & release mechanism to place the box 840 on the drop point 850. The discontinuance of the signal may be done by the drone itself Dr8b which can sense its approach to the drop point 850, or by a Command & Control System from afar which receives visual reports from the drone Dr8b as it approaches the drop point 850. Many other items might be included in a box 840 other than medical supplies, and this need not be a box at all but may be other materials.

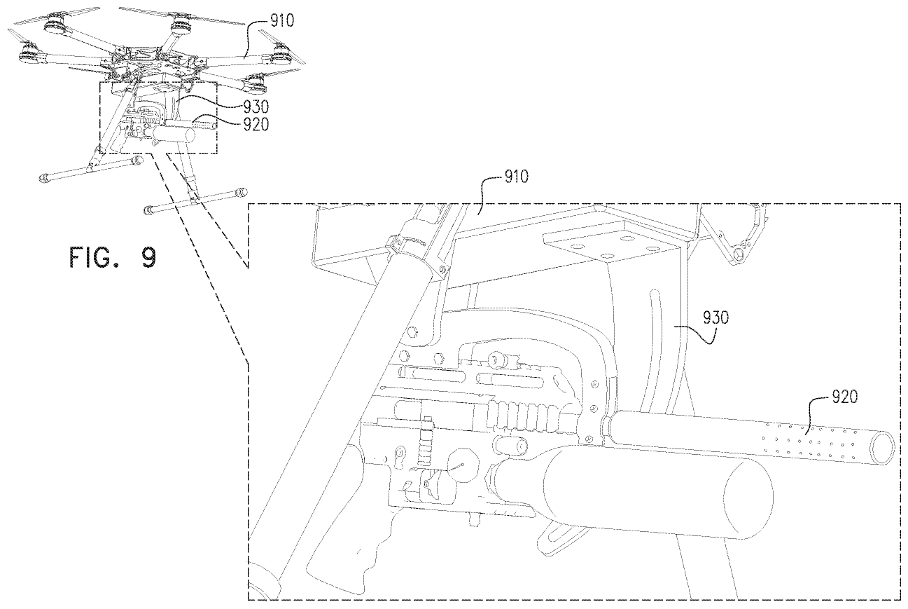

FIG. 9 illustrates a system of a fixed attachment to mobile asset, in which the attachment is a means to disperse crowds. FIG. 9 is one example of a system that may be used as elements 830 and Dr8a in FIG. 8. Element 910 is a mobile asset, in this case a drone, but any asset capable of movement could serve the purpose. The mobile asset 910 is combined with a device, here pepper ball gun 920, for dispersing crowds. These two elements are connected by a connecting mechanism, in this case a bolting device 930 which includes one or more bolts affixing connecting material to the drone 910, and one or more bolts connecting the same connecting material to the gun 920. It will be understand that the connection is not limited solely to bolting, but may be welding, magnetic, tying, or other permanent or semi-permanent connection providing stability for the connections of the connecting material to the drone 910 and the gun 920.

Exemplary Usages: Various embodiments of the invention will prove useful for many different usages, including, without limitation, any or all of the following:
(1) Military operations: According to what is known as “the Revolution in Military Affairs” (“RMA”), drone air fleets are becoming one of the major modes of aerial warfare and may become the predominant mode by the decade of the 2030's. Drones are often referenced as “UAV's,” short for “Unmanned Aerial Vehicles,” but in addition to UAV's, there are now “UGV's” or “Unmanned Ground Vehicles” of many types, and a beginning of “USV's,” short for “Unmanned Surface Vehicles,” essentially ships of various kinds. It is likely that there will be fleets of UAV's, separate fleets of UGV's, and separate fleets of USV's. It is likely that there will also be combined fleets of multiple types of units, all managed on a single controller infrastructure. There will be espionage air fleets, or combined assets fleets, as well, and these may be coordinate with military fleets in the air, on ground, on the sea, and/or in space, managed on one C&C Systems or managed by multiple Systems that are in close and continuous communication with one another.
(2) Civilian operations: In area after area of the civilian economy, mobile assets, particularly unmanned mobile assets, are becoming increasingly important. In many areas of agriculture and water management, such assets are critical for monitoring and measuring the environment. For agriculture, as an example, unmanned mobile assets may help monitor water consumption of plants, fertilizer consumption, or pest infestation. Mobile assets could also be deployed to help manage these factors, by turning on water, or spraying either fertilizer or pest control material. For water management, for example, mobile assets can monitor water flow, points of storage, possible leaks, points and quantities of consumption, and others. Other mobile assets could help execute water management by activating or deactivating points of exist, or plugging leaks.

Depending on the scale of such projects, fleets of mobile assets may be essential. For example, in construction sites, particularly those that include multiple buildings, mobile assets are needed for safety and management, monitoring the creation and management of safety structures such as barriers, or checking to insure that personnel use mandated safety equipment, or monitoring situations to help enhance fire safety. In security situations, infrastructure, and transportation, mobile assets are becoming increasingly important. Various embodiments of the systems and methods described herein will be useful in deploying and managing such mobile assets, possibly in conjunction with fixed assets.
(3) Mixed civilian and military operations: There are usages in which civilian projects must be protected by military assets. One might think, for example, of platforms for the drilling of gas and oil wells, which require civilian assets to complete the project and military assets to protect the platform. Drones or other mobile assets of different types would be deployed, and may be serviced by various embodiments of the C&C Systems described herein. As one example, it is possible to envision a maritime drilling platform, in which mobile assets help monitor drilling progress and safety conditions, while the same mobile assets, or other mobile assets, monitor the area for military threats from the air, on water, or underwater, or the mobile assets either direct friendly military assets responding to threats, or alternatively take military action against the threat.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagrams illustrate non-limiting embodiment/case examples of the methods, and block diagrams illustrate non-limiting embodiment/case examples of the devices. Some operations in the flow diagrams may be described with reference to the embodiments/cases illustrated by the block diagrams. However, the methods of the flow diagrams could be performed by embodiments/cases of the invention other than those discussed with reference to the block diagrams, and embodiments/cases discussed with reference to the block diagrams could perform operations different from those discussed with reference to the flow diagrams. Moreover, although the flow diagrams may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/cases will sometimes be described in singular form for clarity. However, some embodiments/cases may include multiple iterations of a method or multiple instantiations of a mechanism unless noted otherwise. For example, when a controller or an interface are disclosed in an embodiment/case, the scope of the embodiment/case is intended to also cover the use of multiple controllers or interfaces.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the FIG.s may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. A command and control system for management of drone fleets, comprising:
a command and control unit for receiving data, and configured to issue commands for controlling sub-systems; and
wherein the sub-systems are configured to receive the data and transmit it to the command and control unit.

2. The command and control system of claim 1, wherein the sub-systems comprise:
a docking station for storage, charging, launching, and retrieving drones;
a plurality of drones;
an instrument on the drones for receiving and transmitting the data;
a positioning sub-system for determining the positions and orientations of drones in relation to a target; and
static support equipment for receiving data or taking other action.

3. The command and control system of claim 2, further comprising:
a processing device configured to receive the data, and to process the data into a 3D model in relation to the pictorial representation of an area in which the target is located.

4. The command and control system of claim 3, further comprising:
wherein the processing device is configured to transmit the 3D model to the command and control unit.

5. The command and control system of claim 4, further comprising:
the sub-systems are communicatively connected in a mesh network.

6. A method for real-time mapping by a mesh network of a target, comprising:
capturing data about the location of a target by a plurality of drones;
compressing the data by the drones;
applying computer algorithms by the drones to transform the data for each drone into a 3D model of an area in which the target is located;
adding to the 3D models positioning data about the drones to create a shared position map of the location of the target;
processing visual markers with the shared position map into a single map of target location, and the positions and orientations of the drones; and
creating a visual map of the area in which the target is located, such that the single map is configured to be altered as the received data changes over time.

7. The method of claim 6, further comprising repetition of the method described so as to update the single map in real-time.

8. The method of claim 7, further comprising the mesh network transmitting the single map to a command and control unit configured to receive such transmission.

9. The method of claim 8, further comprising the command and control unit combining an external map of the area in which the target is located with the single map in order to produce a unified and updated map of the target and the area in which the target is located.

10. The method of claim 9, further comprising the command and control unit integrating external intelligence into the unified and updated map.

11. A device configured to display dynamic UI about a target, comprising a device with user interface in an initial state showing a map and sensory data from a plurality of drones.

12. The device of claim 11, wherein the device is configured to detect, and to display in the user interface, a change in conditions related to the initial state.

13. The device of claim 12, wherein the detection occurs in real-time relative to the change in conditions, and automatically without human intervention.

14. The device of claim 13, wherein the change in display occurs in real-time relative to the change in conditions, and automatically without human intervention.

15. The device of claim 14, wherein notification of the change to the user occurs in real-time, and wherein the user indicates a manner in which the display should change to best present the change in conditions.

16. A system for real-time mapping of a target, comprising:
a plurality of drones for receiving sensory data from a geographic area and transmitting such data to a portable device;
wherein the portable device is communicatively connected to the plurality of drones, and the portable device is configured to receive the sensory data transmitted from the drones.

17. The system of claim 16, further comprising:
the portable device is configured to process the sensory data received from the plurality of drones to create a real-time 3D model of an area in which a target is located.

18. The system of claim 17, further comprising:
the portable device is configured to send commands to the drones to perform actions in relation to the target.

19. The system of claim 18, further comprising:
the portable device is configured to retransmit the sensory data to a processing device; and
the processing device is configured to process the sensory data received from the portable device to create a real-time 3D model of an area in which a target is located.

20. The system of claim 19, further comprising:
the processing device is configured to send commands to the drones to perform actions in relation to the target.
